(19) United States
(12) Patent Application Publication
(10) Pub. No.: US 2005/0227515 A1
(43) Pub. Date: Oct. 13, 2005

(54) Electrical cable connector

(75) Inventor: Wen-Lung Hsu, Yuan Lin Town (TW)

Correspondence Address: TROXELL LAW OFFICE PLLC, SUITE 1404, 5205 LEESBURG PIKE, FALLS CHURCH, VA, 22041, US

(73) Assignee: Golden Bridge Electech Inc.

(21) Appl. No.: 10/820,803

(22) Filed: Apr. 9, 2004

(51) Int. Cl. H01R 4/66

(52) U.S. Cl. 439/98

(57) ABSTRACT

An electrical cable connector of the present invention is provided. The present invention includes a plurality of terminal insulating bodies and a transmission cable connected with a plurality of terminals. Each of a plurality of terminals has a holding portion at its one end, and a corresponding tooth-liked snap piece is provided at one end of the terminals. A contact portion is provided at the other end of each of a plurality of terminals, and a holding segment is provided between the contact portion and the holding portion. Two interference portions are respectively provided at the side portion of the holding segment. The transmission cable has an insulating cover layer and two electrical cable groups formed within the insulating cover layer. The electrical cable groups are wrapped by a metal shielding, and a first ground cable consists of a plurality of twisted pair wires. A second ground cable is provided outside of the electrical cable groups, and the two electrical cable groups and the first and the second ground cables are respectively connected to the holding portions of a plurality of terminals. With a plurality of terminals for holding the electrical cable, grounding area of the electrical cable is increased to prevent electromagnetic interruption (EMI). Thus, the electrical cable is more flexible and has a higher tensile strength and is not prone to be broken so that yield is higher.

### BACKGROUND OF THE INVENTION

1. Field of the Invention

The present invention relates to an electrical cable connector, and in particular to a electrical cable for holding a plurality of terminals to increase grounding area of the electrical cable and to efficiently prevent electromagnetic interruption (EMI) so that the electrical cable is more flexible and has larger tensile strength. The electrical cable is not prone to breakage and has a higher production line yield.

2. Description of Related Art

Conventionally, an electrical cable as shown in U.S. Pat. No. 6,444,902 B1 includes a pair of signal transmission groups. Each group has a pair of signal conductors wrapped by insulated layers respectively and a metal shielding wrapped on the pair of signal conductors. A pair of first non-insulated drain wires are disposed between the pair of signal conductors, and a pair of second non-insulated drain wires are disposed outside of the pair of signal conductors. The first and second non-insulated drain wires are in electrical connect with an outer surface of the metal shielding to provide a proper grounding.

However, although the conventional electrical cable provides a proper grounding and the width of the electrical cable is reduced, the first and second non-insulated drain wires are merely conductors with single core, grounding area is significantly insufficient. Even worse, the conductor with single core is engaged with the connector so that the conductor is prone to be broken because of stiffer strength of the conductor with single core and its less flexibility. It fails to provide tensile strength and to improve production line yield.

Furthermore, the electrical cable is connected with a terminal of the connector when the electrical cable is in use. However, the conductor is typically connected with the terminal by welding. The volume of the electrical cable and the terminal is small, so it is troublesome and time-consuming to weld the electrical cable and the terminal. Further, the welding zone is in the proximity of the housing of the connector, so the housing of the electrical components is prone to be melted because of high temperature. Thus, there is need to development of an electrical cable.

### SUMMARY OF THE DISCLOSURE

It is an object of the present invention to provide an electrical cable for holding a plurality of terminals.

It is another object of the present invention to efficiently prevent electromagnetic interruption (EMI) and increase grounding area of the electrical cable by multiple twisted electrical wires. The electrical cable has a desired flexibility and enhanced tensile strength, and the electrical cable is not prone to be broken and has a high production line yield after assembly.

In order to accomplish the object of the present invention, the present invention includes a plurality of terminal insulating bodies and a transmission cable connected with a plurality of terminals. Each of a plurality of terminals has a holding portion at its one end, and a corresponding tooth-liked snap piece is provided at one end of the terminals. A contact portion is provided at the other end of each of a plurality of terminals, and a holding segment is provided between the contact portion and the holding portion. Two interference portions are respectively provided at the side portion of the holding segment. The transmission cable has an insulating cover layer and two electrical cable groups formed within the insulating cover layer. The electrical cable groups are wrapped by a metal shielding, and a first ground cable consists of a plurality of twisted pair wires. A second ground cable is provided outside of the electrical cable groups, and the two electrical cable groups and the first and the second ground cables are respectively connected to the holding portions of a plurality of terminals. With a plurality of terminals for holding the electrical cable, grounding area of the electrical cable is increased to prevent electromagnetic interruption (EMI). Thus, the electrical cable is more flexible and has a higher tensile strength and is not prone to be broken so that yield is higher.

### BRIEF DESCRIPTION OF DRAWINGS

The present invention can be fully understood from the following detailed description and preferred embodiment with reference to the accompanying drawings in which:

FIG. 1 is a perspective view of an electrical cable in accordance with one embodiment of the present invention;

FIG. 2 is an exploded view of the electrical cable of FIG. 1;

FIG. 3 is a cross-sectional view of the electrical cable of FIG. 1;

FIG. 4 is a perspective view of the present invention with the terminals and the electrical cables assembled; and

FIG. 5 is a perspective view of the electrical cable in accordance with another embodiment of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

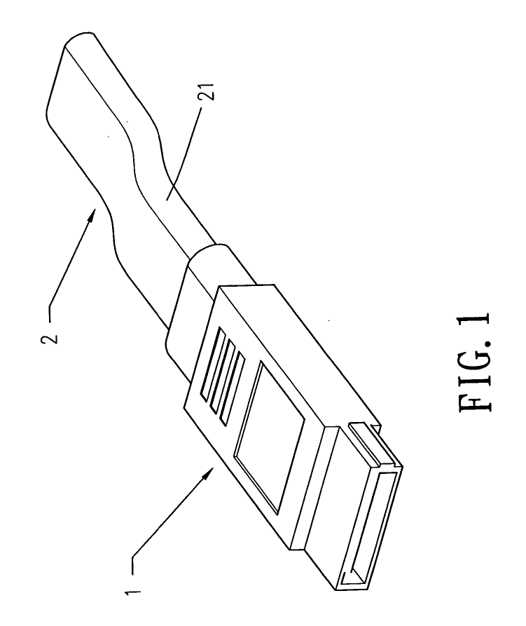

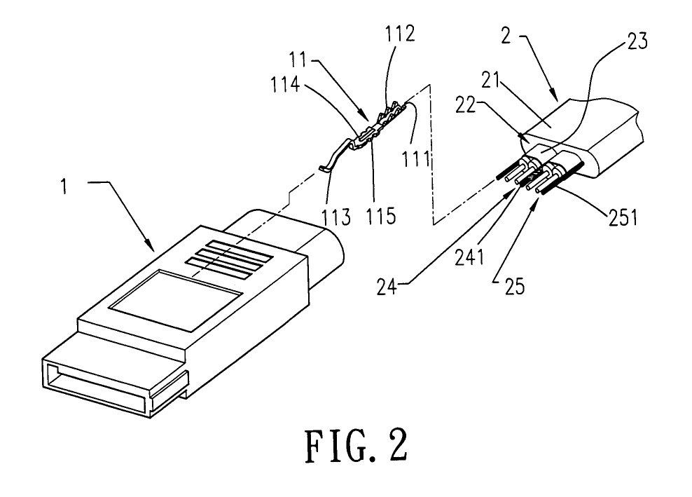

Referring to FIGS. 1 and 2, a perspective view and an exploded view of the present invention are provided. As shown in FIGS. 1-2, the present invention relates to an electrical cable connector for Serial ATA (SATA) connector. The electrical cable connector has an insulating body 1 and a transmission cable 2 so that a plurality of terminals 11 of the insulating body 1 is easy to hold sufficient electrical wires and the grounding area of the transmission cable 2 increases. Thus, it prevents electromagnetic interruption (EMI), and the transmission cable 2 is more flexible and has tensile strength. Besides, the transmission cable 2 is not prone to be broken and has a better production line yield after assembly.

A plurality of terminals 11 are positioned within the insulating body 1, and a holding portion 111 is provided at one end of the terminals 11. The holding portion 111 is a U-shaped groove, and a corresponding tooth-liked snap piece 112 is provided at one end of the terminals 111. A contact portion 113 is provided at the other end of each of a plurality of terminals 11, and a holding segment 114 is provided between the contact portion 113 and the holding portion 111. Two interference portions 115 are respectively provided at the side portions of the holding segment 114.

The transmission cable 2 has an insulating cover layer 21 and two electrical cable groups 22 formed within the insulating cover layer 21. The electrical cable group 22 is wrapped by a metal shielding 23, and a first ground cable 24 consists of a plurality of twisted pair wires 241. A second ground cable 25 is provided outside of the electrical cable groups 22, and the two electrical cable groups 22 and the first and the second ground cables 24 and 25 are respectively connected to the holding portions 111 of a plurality of terminals 11.

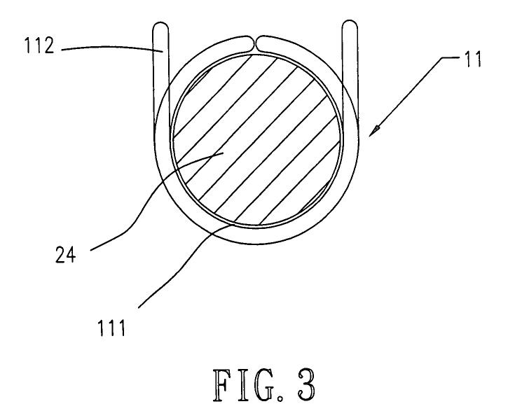

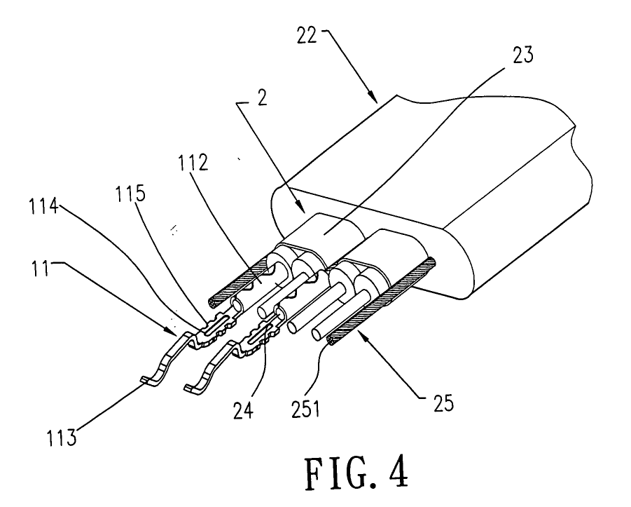

Referring to FIGS. 3 and 4, a cross-sectional view of the present invention with the terminals and the electrical cables assembled. As shown in FIGS. 3 and 4, when a plurality of terminal 11 are provided within the insulating body 1, the terminals 11 is tightly engaged within the insulating body 1 because of interference between the terminals 11 and the interference portions 115. The terminals 11 will not disengage with the insulating body 1 by pulling the terminals 11 improperly. Besides, when the transmission cable 2 and a plurality of terminals 11, the two electrical cable groups 22 and the first and the second ground cables 24 and 25 are respectively placed within the holding portions 111 of a plurality of terminals 11. Then, the holding portion 111 is held by a tool (not shown) so that the tooth-liked snap piece 112 of the terminals 111 is pushed in the same direction. Thus, the tooth-liked snap piece 112 of the terminals 111 is engaged with the first ground cable 24 and the second ground cable 25. With a plurality of terminals 111 for holding the electrical cable, grounding area of the transmission cable 2 is increased to prevent electromagnetic interruption (EMI). Thus, the transmission cable 2 is more flexible and has a higher tensile strength and is not prone to be broken so that yield is higher.

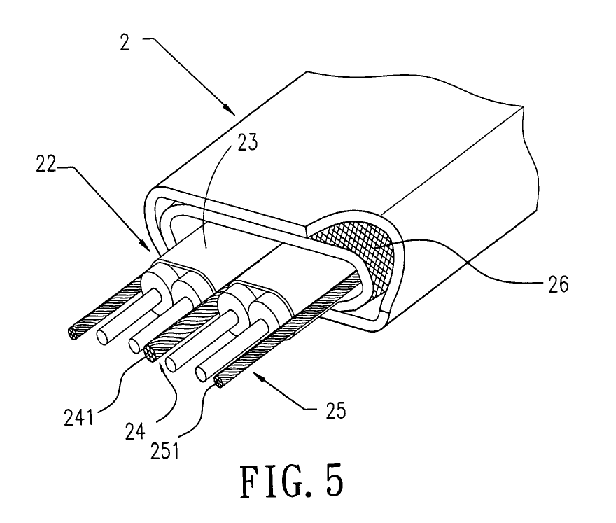

Referring to FIG. 5, another embodiment of the present invention is shown. As shown in FIG. 5, a metallic woven screen 26 is provided between the insulating cover layer 21 and the metal shielding 23 of the transmission cable 2.

As mentioned above, the tooth-liked snap piece of the holding portion is easy to hold the electrical cable and two ground cables. Besides, the ground cables have a plurality of twisted pair wires and grounding area of the electrical cable is increased to prevent electromagnetic interruption (EMI). Thus, the electrical cable is more flexible and has a higher tensile strength and is not prone to be broken so that yield is higher.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

1. An electrical cable connector, comprising:
a plurality of terminals, provided within an insulating body and having a holding portion at its one end, and a corresponding tooth-liked snap piece provided at one end of the terminals, a contact portion provided at the other end of each of a plurality of terminals, and a holding segment provided between the contact portion and the holding portion, two interference portions respectively provided at the side portion of the holding segment;
a transmission cable, having an insulating cover layer and two electrical cable groups formed within the insulating cover layer, the electrical cable groups wrapped by a metal shielding, and a first ground cable consisting of a plurality of twisted pair wires, a second ground cable provided outside of the electrical cable groups, and the two electrical cable groups and the first and the second ground cables respectively connected to the holding portions of a plurality of terminals. With a plurality of terminals for holding the electrical cable, grounding area of the electrical cable is increased to prevent electromagnetic interruption (EMI).

2. The electrical cable connector as claimed in claim 1, wherein the holding portion is a U-shaped groove.

3. The electrical cable connector as claimed in claim 1, wherein the second ground cable has a plurality of twisted pair wires.

4. The electrical cable connector as claimed in claim 1, wherein a metallic woven screen is provided between the insulating cover layer and the metal shielding of the transmission cable.
